(19) United States
(12) Patent Application Publication
(10) Pub. No.: US 2015/0074216 A1
(43) Pub. Date: Mar. 12, 2015

(54) DISTRIBUTED AND PARALLEL DATA PROCESSING SYSTEMS INCLUDING REDISTRIBUTION OF DATA AND METHODS OF OPERATING THE SAME

(71) Applicant: Samsung Electronics Co., Ltd., Suwon-si (KR)

(72) Inventor: Sang-Kyu Park, Suwon-si (KR)

(21) Appl. No.: 14/477,234

(22) Filed: Sep. 4, 2014

(30) Foreign Application Priority Data
Sep. 12, 2013 (KR) 10-2013-0109421

(51) Int. Cl. H04L 12/24; H04L 29/08

(52) U.S. Cl. CPC H04L 41/046; H04L 67/10
USPC 709/208

(57) ABSTRACT

Methods of operating a scalable data processing system including a master server that is coupled to a plurality of slave servers that are configured to process data using a Hadoop framework by determining respective data processing capabilities of each of the slave servers and during an idle time, and redistributing un-processed data from a lower performance slave server to a higher performance slave server based on the determined respective data processing capabilities.

### CROSS-REFERENCE TO RELATED APPLICATION

This application claims priority under 35 USC §119 to Korean Patent Application No. 10-2013-0109421, filed Sep. 12, 2013 in the Korean Intellectual Property Office (KIPO), the contents of which are hereby incorporated herein by reference in its entirety.

### FIELD

Example embodiments relate to a data processing system, and more particularly to a distributed and parallel data processing system and a method of operating the same.

### BACKGROUND

The amount of data associated with the Internet service markets has increased. Internet portals may deploy large scale clusters for distributed management of big data and distributed and parallel data processing using, for example, MapReduce by Google, Hadoop MapReduce by Apache Software Foundation, or the like. It is known that when a data processing cluster is deployed using heterogeneous servers, the heterogeneous servers may have different data processing capabilities. When the same amount of data is assigned to each of the heterogeneous servers the overall data processing time of the data processing cluster may be determined by the heterogeneous server having the least data processing capability.

### SUMMARY

Embodiments according to the inventive concept can provide distributed and parallel data processing systems and method of operating the same. Pursuant to these embodiments methods of operating a scalable data processing system including a master server that is coupled to a plurality of slave servers that are configured to process data using a Hadoop framework, can be provided by determining respective data processing capabilities of each of the slave servers and during an idle time, redistributing un-processed data from a lower performance slave server to a higher performance slave server based on the determined respective data processing capabilities.

In some embodiments according to the inventive concept, determining the respective data processing capabilities of each of the slave servers can be provided by performing respective MapReduce tasks on the slave servers using equal amounts of data for each task. In some embodiments according to the inventive concept, the equal amounts of data can be less than all of the data provided to each of the slave server so that at least some data remains unprocessed when the respective data processing capabilities are determined.

In some embodiments according to the inventive concept, the idle time can be an interval where an average utilization of the slave servers is less than or equal to a reference value. In some embodiments according to the inventive concept, the data can be a first job, where the method can further include receiving data for a second job and distributing the second data unequally among the slave servers based on the respective data processing capabilities of each of the slave servers.

In some embodiments according to the inventive concept, a method of operating a distributed and parallel data processing system including a master server and at least first through third slave servers, can be provided by calculating first through third data processing capabilities of the first through third slave servers for a MapReduce task performed on respective input data blocks provided to each of the first through third slave servers, where each MapReduce task running on a respective central processing unit is associated with one of the first through third slave servers. The first through third data processing capabilities can be transmitted from the first through third slave servers to the master server. Using the master server, tasks assigned to the first through third slave servers can be reassigned based on the first through third data processing capabilities during a first idle time of the distributed and parallel data processing system.

In some embodiments according to the inventive concept, when the first slave server has a highest data processing capability among the first through third data processing capabilities and the third slave server has a lowest data processing capability among the first through third data processing capabilities, where the redistributing can be provided by moving, using the master server, at least some data stored in the third slave server to the first slave server.

In some embodiments according to the inventive concept, a distributed and parallel data processing system can include a master server and at least first through third slave servers connected to the master server by a network. Each of the first through third slave servers can include a performance metric measuring daemon configured to calculate a respective one of the first through third data processing capabilities of the first through third slave servers using a MapReduce task performed on respective input data blocks provided to each of the first through third slave servers, where the data processing capabilities are transmitted to the master server. The master server can be configured to redistribute tasks assigned to the first through third slave servers based on the first through third data processing capabilities during an idle time of the distributed and parallel data processing system.

In some embodiments according to the inventive concept, the master server can include a performance metric collector that can be configured to receive the first through third data processing capabilities and data distribution logic can be associated with the performance metric collector, where the data distribution logic configured to redistribute the tasks assigned to the first through third slave servers based on the first through third data processing capabilities.

### BRIEF DESCRIPTION OF THE DRAWINGS

Illustrative, non-limiting example embodiments will be more clearly understood from the following detailed description in conjunction with the accompanying drawings.

FIG. 1 is a block diagram illustrating a distributed and parallel data processing system according to example embodiments of the inventive concept.

FIG. 2 illustrates the MapReduce task performed using the distributed and parallel data processing system of FIG. 1.

FIG. 3 illustrates an example of the user interface in FIG. 1 according to example embodiments of the inventive concept.

FIG. 4 illustrates one of slave servers in FIG. 1 according to example embodiments of the inventive concept.

FIG. 5 illustrates a register that may be included in the performance metric collector in FIG. 1.

FIG. 6 is a diagram illustrating the first through third data processing capabilities in some embodiments according to the inventive concept.

FIG. 7 is a diagram illustrating the idle time of the distributed and parallel data processing system of FIG. 1.

FIG. 8 is a diagram illustrating operations of the distributed and parallel data processing system after the data processing capabilities are calculated in some embodiments according to the inventive concept.

FIG. 9 is a diagram illustrating data processing time of the distributed and parallel data processing system after the data is redistributed in some embodiments according to the inventive concept.

FIG. 10 is a flowchart illustrating methods of operating distributed and parallel data processing system according to example embodiments of the inventive concept.

FIG. 11 illustrates redistributing the task in FIG. 10.

FIG. 12 illustrates a new slave server added to (or included in) the distributed and parallel data processing system in some embodiments according to the inventive concept.

FIG. 13 is a flowchart illustrating methods of operating a distributed and parallel data processing system according to example embodiments of the inventive concept.

FIG. 14 illustrates physical distribution architecture of Hadoop cluster to which the method according to example embodiments can be applied in some embodiments according to the inventive concept.

FIG. 15 is a block diagram illustrating an exemplary master/slave server in some embodiments according to the inventive concept.

### DETAILED DESCRIPTION OF THE EMBODIMENTS ACCORDING TO THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

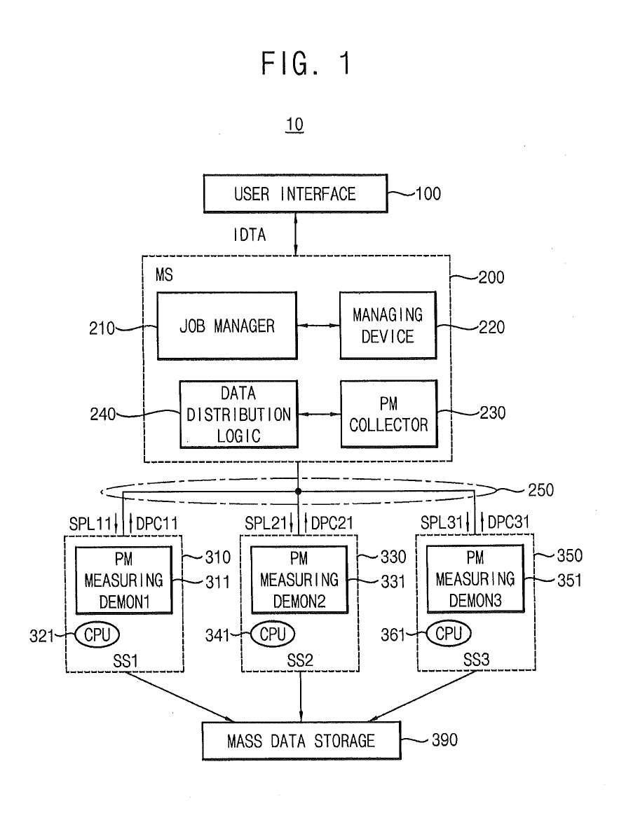

FIG. 1 is a block diagram illustrating a distributed and parallel data processing system according to example embodiments of the inventive concept.

Referring to FIG. 1, a distributed and parallel data processing system 10 includes a user interface 100, at least one master server 200 and at least first through third slave servers 310, 330 and 350. The master server 200 may be referred to as a name node and each of the first through third slave servers 310, 330 and 350 may be referred to as a data node.

The distributed and parallel data processing system 10 defines a user job using a MapReduce framework, where a map and reduce function may be implemented using a user interface provided as MapReduce library.

The user may easily define a job and perform the defined job using the map and reduce functions without considering the details of how the distributed and parallel data processing, data distribution and scheduling are to occur.

The user interface 100 provides user input/output and the user job input to the user interface 100 may be provided to the master server as user data IDTA.

FIG. 3 illustrates an example of the user interface in FIG. 1 according to example embodiments of the inventive concept.

Referring to FIG. 3, the user interface 100 may include an application program 110, a parallel processing library 120 and a web browser 130.

When the user interface 100 provides the user input and output through the application program 110 via the web browser 130. The user requests to know a desired job by applying the map function or the reduce function in the parallel processing library 120 to the user job 140 through the application program 110. The map function is used for executing a map task and the reduce function is used for executing a reduce task. The user interface 100 may apply the map function or the reduce function to the user job 140 to provide the user data IDTA to the master server 200.

Referring back to FIG. 1, the master server 200 is connected to the first through third slave servers 310, 330 and 350. The master server 200 includes a job manager 210, a managing device 220, a performance metric collector 230 and a data distribution logic 240.

The job manager 210 divides the user data IDTA into a plurality of equally sized data blocks SPL11, SPL21 and SPL31 and allocates the data blocks SPL11, SPL21 and SPL31 to the first through third slave servers 310, 330 and 350, respectively. The managing device 220 may provide a status of the job to the user and may provide status information for the first through third slave servers 310, 330 and 350.

The first through third slave servers 310, 330 and 350 may be homogeneous servers having different data processing capabilities or may be heterogeneous servers having different data processing capabilities.

The performance metric collector 230 may collect first through third data processing capabilities DPC11, DPC21 and DPC31 from the first through third slave servers 310, 330 and 350 respectively and may store the first through third data processing capabilities DPC11, DPC21 and DPC31.

The data distribution logic 240 is connected to the performance metric collector 230 may redistribute tasks allocated to the first through third slave servers 310, 330 and 350 based on the first through third data processing capabilities DPC11, DPC21 and DPC31. The redistribution may occur during an idle time of the distributed and parallel data processing system 10. For example, the data distribution logic 240 may move at least some of data stored in the source slave server having the lowest data processing capability of the first through third data processing capabilities DPC11, DPC21 and DPC31 to a target slave server that has the highest data processing capability of the first through third data processing capabilities DPC11, DPC21 and DPC31 based on the first through third data processing capabilities DPC11, DPC21 and DPC31.

The first slave server 310 may include a performance metric measuring daemon 311 and a central processing unit (CPU) 321. The CPU 321 runs the Map function and the Reduce function to perform MapReduce task on the first data block SPL11 and the performance metric measuring daemon 311 measures a time required for processing the first data block SPL11 to calculate the first data processing capability DPC11. The second slave server 330 may include a performance metric measuring daemon 331 and a CPU 341. The CPU 341 runs the Map function and the Reduce function to perform MapReduce task on the second data block SPL21 and the performance metric measuring daemon 331 measures a time required for processing the second data block SPL21 to calculate the second data processing capability DPC21. The third slave server 350 may include a performance metric measuring daemon 351 and a CPU 361. The CPU 361 runs the Map function and the Reduce function to perform MapReduce task on the third data block SPL31 and the performance metric measuring daemon 351 measures a time required for processing the third data block SPL31 to calculate the third data processing capability DPC31.

The first through third slave servers 310, 330 and 350 process the first through third data blocks SPL11, SPL21 and SPL31 respectively and generate result files which the user requires to store the generated result files in a mass data storage 390.

At least some or all of the performance metric collector 230, the data distribution logic 240 and the performance metric measuring daemons 311, 331 and 351 may be stored in computer-readable media and may be implemented with software including computer-readable codes and/or data.

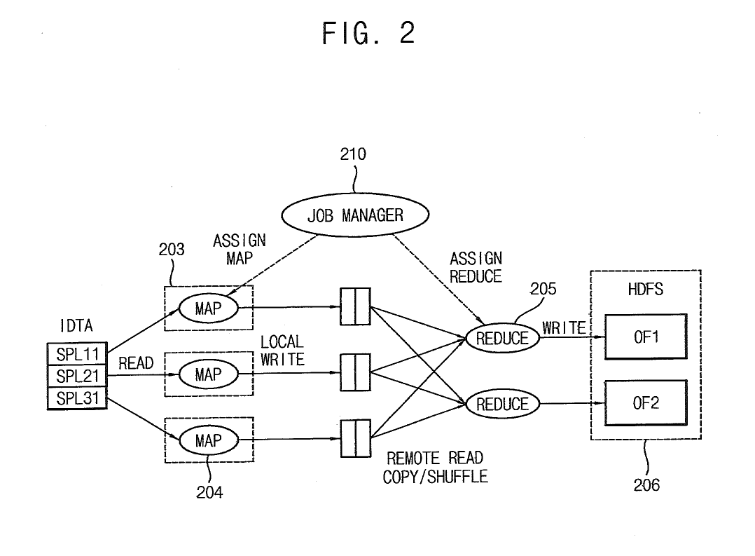

FIG. 2 illustrates the MapReduce task performed in the distributed and parallel data processing system of FIG. 1.

Referring to FIG. 2, the user data IDTA provided via the user interface 100 in response to the user job 140 may represent codes and input files. The job manager 210 divides the user data IDTA into first through third data blocks SPL11, SPL21 and SPL31 which are assigned to a respective task manager 203 implemented in each of the slave servers 310, 330 and 350. The task manager 203 executes the map task 204 to generate intermediate result files in the form of key-value pairs on each of the first through third data blocks SPL11, SPL21 and SPL31. After the map task 204 is complete, the task manager 203 executes the reduce task 205. The reduce task 205 fetches the intermediate result files from each of the first through third data blocks SPL11, SPL21 and SPL31 according to the keys, conducts the reduce function to eliminate redundant keys and stores output files OF1 and OF2 arranged according to the keys in a Hadoop distributed file system (HDFS) 206.

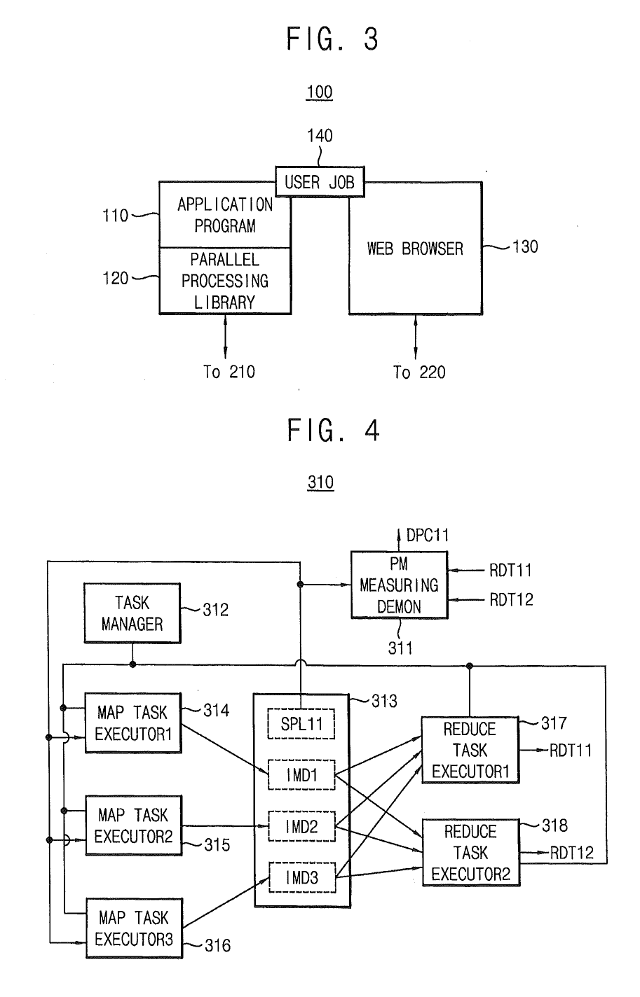

FIG. 4 illustrates one of slave servers in FIG. 1 according to example embodiments according to the inventive concept.

In FIG. 4, configuration of the first slave server 310 is illustrated. The configuration of the second and third slave servers 330 and 350 may be substantially the same as the configuration of the first slave server 310.

Referring to FIG. 4, the first slave server 310 includes the performance metric measuring daemon 311, a task manger 312, a local disk 313, first through third map task executors 314, 315 and 316 and first and second reduce task executors 317 and 318.

The local disk 313 stores the first data block SPL1 from the master server 200, which is provided to the first through third map task executors 314, 315 and 316.

When the task manager 312 receives the first data block SPL11 and executes the MapReduce task, the task manager 312 generates and manages operation of the first through third map task executors 314, 315 and 316 that actually execute the map task and the first and second reduce task executors 317 and 318 that actually execute the reduce task on the CPU 321. In some embodiments, the task manager 312 may not actually receive the data blocks but rather may manage the data (and execution) via an agent. The first through third map task executors 314, 315 and 316 and the first and second reduce task executors 317 and 318 may be stored in a memory while the map task or the reduce task is executed. The first through third map task executors 314, 315 and 316 and the first and second reduce task executors 317 and 318 may be removed from the memory after the individual task is completed.

The map task can extract the key-value pairs from the first data block SPL11 and the reduce task can eliminate redundant keys from the extracted key-value pairs and generate desired key-value pairs (or result data files) using business logic.

The first through third map task executors 314, 315 and 316 extract the key-value pairs from partitions of the first data block SPL11 to store the extracted key-value pairs in the local disk 313 as first through third intermediate data IMD1, IMD2 and IMD3 respectively. The first and second reduce task executors 317 and 318 eliminate redundant key(s) of the first through third intermediate data IMD1, IMD2 and IMD3 to generate result data RDT11 and RDT12.

The performance metric measuring daemon 311 may calculate a first data processing time from a time point when the first data block SPL11 stored in the local disk 313 is provided to the first through third map task executors 314, 315 and 316 to a time when the first and second reduce task executors 317 and 318 generate the result data RDT11 and RDT12. The performance metric measuring daemon 311 provides the performance metric collector 230 with the first data processing capability DPC11 based on the calculated first data processing time.

Similarly, the performance metric measuring daemon 331 in the second slave server 330 may calculate second data processing time from a time when the second data block SPL21 stored in a local disk is provided to the first through third map task executors to a time when the first and second reduce task executors generate the result data. The performance metric measuring daemon 331 provides the performance metric collector 230 with the second data processing capability DPC21 based on the calculated second data processing time.

In addition, the performance metric measuring daemon 351 in the third slave server 350 may calculate second data processing time from a time when the third data block SPL31 stored in a local disk is provided to the first through third map task executors to a time when the first and second reduce task executors generate the result data. The performance metric measuring daemon 351 provides the performance metric collector 230 with the third data processing capability DPC31 based on the calculated third data processing time.

The performance metric measuring daemons 311, 331 and 351 in the respective first through slave servers 310, 330 and 350 may calculate the first through third data processing capabilities DPC11, DPC21 and DPC31 respectively during data processing time while the MapReduce task is initially performed on the first through third data blocks SPL11, SPL21 and SPL31 respectively to provide the first through third data processing capabilities DPC11, DPC21 and DPC31 to the performance metric collector 230. The data distribution logic 240 may move (i.e., redistribute) at least some of the data blocks that are stored in each local disk and are not processed by the slave servers 310, 330 and 350 based on the first through third data processing capabilities DPC11, DPC21 and DPC31. The redistribution may be performed during an idle time of the distributed and parallel data processing system 10. The first through third slave servers 310, 330 and 350 may be homogeneous servers having different data processing capabilities or may be heterogeneous servers having different data processing capabilities. As appreciated by the present inventors, when the first through third slave servers 310, 330 and 350 have different data processing capabilities, the time needed to perform the user job may be determined by the slave server having lowest data processing capability unless otherwise addressed as described herein in some embodiments according to the inventive concept.

Accordingly, when the distributed and parallel data processing system 10 includes a plurality of slave servers having different data processing capabilities, the data distribution logic 240 may redistribute at least some of unprocessed data block stored in a local disk of a slave server having lowest data processing capability (source slave server) to a local disk of a slave server having the highest data processing capability (target slave server) so that target slave server can process the redistributed data. Therefore, the time needed for the user job in the distributed and parallel data processing system 10 may be reduced.

In some embodiments, the data distribution logic 240 may be incorporated in the job manager 210. When the data distribution logic 240 is incorporated in the job manager 210, the job manager 210 may redistribute the unprocessed data blocks stored in the first through third slave servers 310, 330 and 350 among the first through third slave servers 310, 330 and 350 according to the first through third data processing capabilities DPC11, DPC21 and DPC31 during the idle time of the distributed and parallel data processing system 10. When the user requests a new job, the job manager 210 may distribute the new job non-uniformly among the first through third slave servers 310, 330 and 350 based on the daemon determined first through third data processing capabilities DPC11, DPC21 and DPC31.

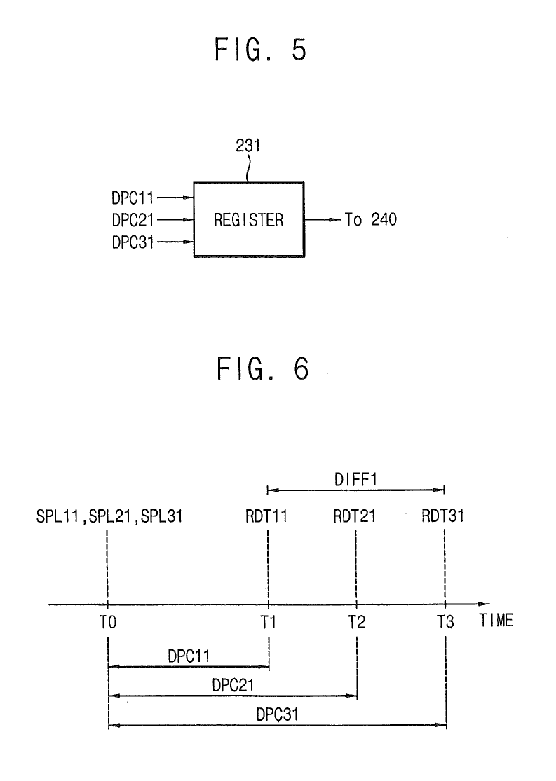

FIG. 5 illustrates a register that may be included in the performance metric collector in FIG. 1.

Referring to FIGS. 1 and 5, the performance metric collector 230 may include a register 231, and the register 231 may store the first through third data processing capabilities DPC11, DPC21 and DPC31 from the first through third slave servers 310, 330 and 350 respectively.

FIG. 6 is a diagram illustrating the first through third data processing capabilities.

Referring to FIG. 6, at a time T0, the MapReduce task executions are initiated on the first through third data blocks SPL11, SPL21 and SPL31 in the first through third slave servers 310, 330 and 350 respectively. The MapReduce task execution on the first data block SPL11 is completed in the first slave server 310 and the result data RDT11 is output at a time T1, the MapReduce task execution on the second data block SPL21 is completed in the second slave server 330 and the result data RDT21 is output at a time T2, and the MapReduce task execution on the third data block SPL31 is completed in the third slave server 350 and the result data RDT31 is output at a time T3. An interval between the times T0˜T1 corresponds to the first data processing capability DPC11 of the first slave server 310, an interval between the times T0˜T2 corresponds to the second data processing capability DPC21 of the second slave server 330, and an interval between the times T0˜T3 corresponds to the third data processing capability DPC31 of the third server 350. The third and first data processing capabilities DPC31 and DPC11 have a difference DIFF1.

The first slave server 310 has a highest data processing capability of the first through third slave servers 310, 330 and 350 and the third slave server 350 has the lowest data processing capability of the first through third slave servers 310, 330 and 350. Accordingly, the master server 200 may move at least some of unprocessed data blocks stored in the local disk of the third slave server 350 to the local disk of the first slave server 310 during the idle time of the distributed and parallel data processing system 10.

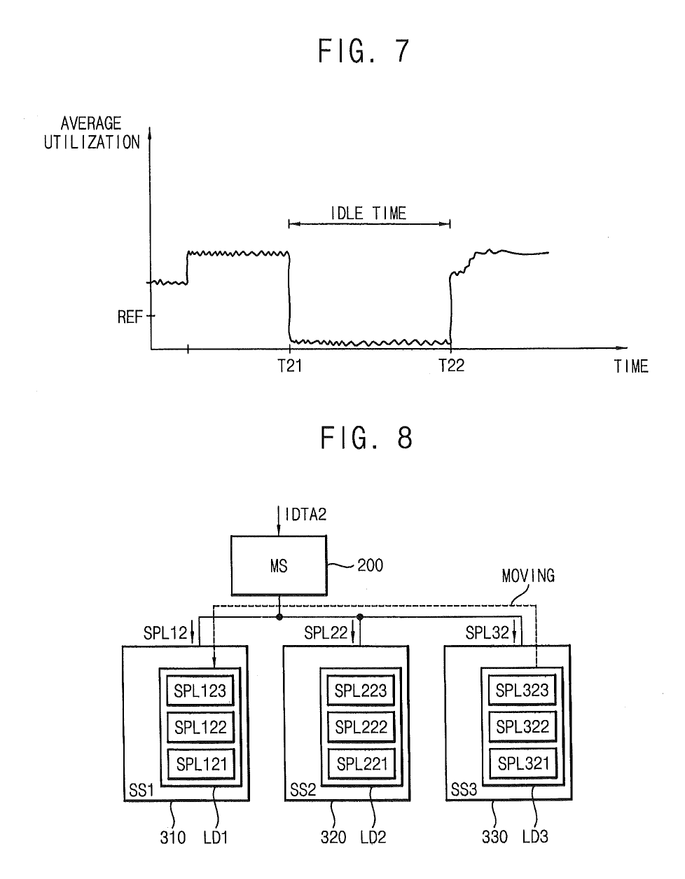

FIG. 7 is a diagram illustrating an idle time of the distributed and parallel data processing system of FIG. 1.

Referring to FIGS. 1 and 7, the idle time of the distributed and parallel data processing system 10 may correspond to an interval when no user job exists, the user data IDTA does not exist in the master server 200 or average utilization of the CPUs 321, 341 and 361 in the first through third slave servers 310 and 330 and 350 is equal to or less than a reference value REF. The average utilization of the CPUs 321, 341 and 361 in the first through third slave servers 310 and 330 and 350 during an interval between times T21 and T22 is less than the reference value REF, and thus the interval between times T21 and T22 may correspond to the idle time of the distributed and parallel data processing system 10. The master server 200 may move at least some of unprocessed data blocks stored in the local disk of the third slave server 350 to the local disk of the first slave server 310 during the idle time of the distributed and parallel data processing system 10.

FIG. 8 is a diagram for illustrating operation of the distributed and parallel data processing system after the data processing capabilities are calculated.

Referring to FIGS. 1 and 8, after the first through third data processing capabilities DPC11, DPC21 and DPC31 are determined, additional user data IDTA2 is input to the master server 200 before the idle time of the distributed and parallel data processing system 10. The job manager 210 of the master server 200 divides the user data IDTA2 into equally sized data blocks SPL12, SPL22 and SPL32 which are distributed to the first through third slave servers 310, 330 and 350 respectively. Each of the data blocks SPL12, SPL22 and SPL32 is stored in each of local disks LD1, LD2 and LD3 in each of first through third slave servers 310, 330 and 350. The data block SPL12 is divided into partitions SPL121, SPL122 and SPL123 and the partitions SPL121, SPL122 and SPL123 are stored in the local disk LD1. The data block SPL22 is divided into partitions SPL221, SPL222 and SPL223 and the partitions SPL221, SPL222 and SPL223 are stored in the local disk LD2. The data block SPL32 is divided into partitions SPL321, SPL322 and SPL323 and the partitions SPL321, SPL322 and SPL323 are stored in the local disk LD3.

When the initial MapReduce task on the user data IDTA is complete and the distributed and parallel data processing system 10 enters into an idle time, the data distribution logic 240 of the master server 200 moves some SPL323 of the data block SPL32 stored in the local disk LD3 of the third slave server 350 to the local disk LD1 of the first slave server 310. After the idle time of the distributed and parallel data processing system 10, the first slave server 310 executes the MapReduce task on the partitions SPL121, SPL122, SPL123 and SPL323, the second slave server 330 executes the MapReduce task on the partitions SPL221, SPL222 and SPL223 and the third slave server 350 executes the MapReduce task on the partitions SPL321 and SPL322. Accordingly, data processing time of the third slave server 350 having the lowest data processing capability is reduced, and thus the overall data processing time of the distributed and parallel data processing system 10 may be also reduced.

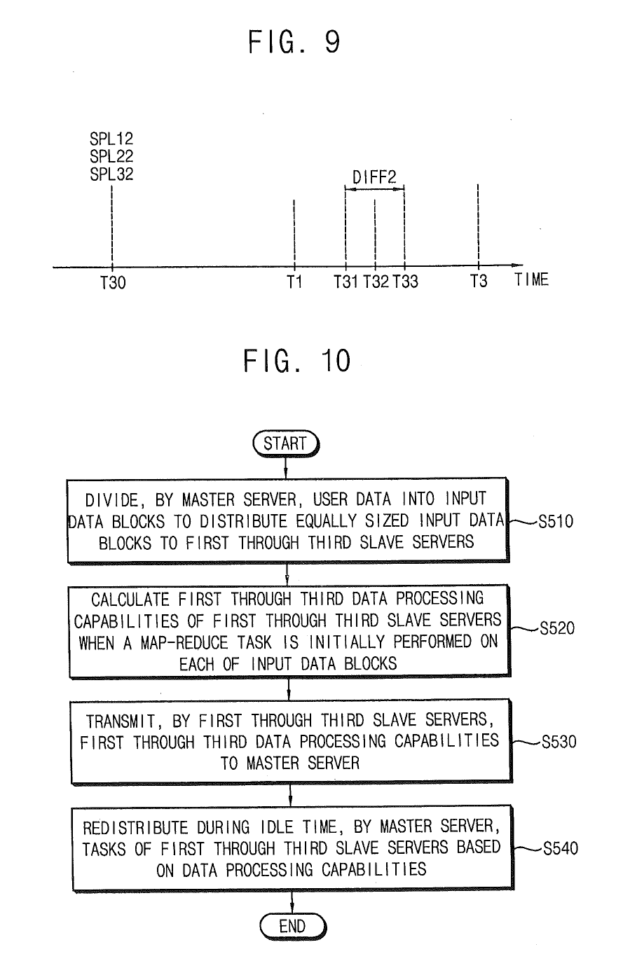

FIG. 9 is a diagram illustrating data processing time of the distributed and parallel data processing system after the data is redistributed.

Referring to FIGS. 8 and 9, when the distributed and parallel data processing system 10 enters into an idle time, the data distribution logic 240 of the master server 200 moves some SPL323 of the data block SPL32 stored in the local disk LD3 of the third slave server 350 to the local disk LD1 of the first slave server 310. When the idle time is over, the first slave server 310 executes the MapReduce task on the partitions SPL121, SPL122, SPL123 and SPL323 to generate corresponding result data during an interval between times T0 and T31, the second slave server 330 executes the MapReduce task on the partitions SPL221, SPL222 and SPL223 to generate corresponding result data during an interval between times T0 and T32, and the third slave server 350 executes the MapReduce task on the partitions SPL321 and SPL322 to generate corresponding result data during an interval between times T0 and T33.

When FIG. 9 is compared with FIG. 6, the data processing time of the first slave server 310 is increased from the time T1 to the time T31, the data processing time of the second slave server 330 is the time T32 that is the same as the time T2 and the processing time of the third slave server 350 is decreased from the time T3 to the time T33. The data processing times of the third and first slave servers 350 and 310 have a difference DIFF2 which is less than the difference DIFF1 in FIG. 6. Accordingly, data processing time of the third slave server 350 having the lowest data processing capability is reduced, and thus the overall data processing time of the distributed and parallel data processing system 10 may be also reduced.

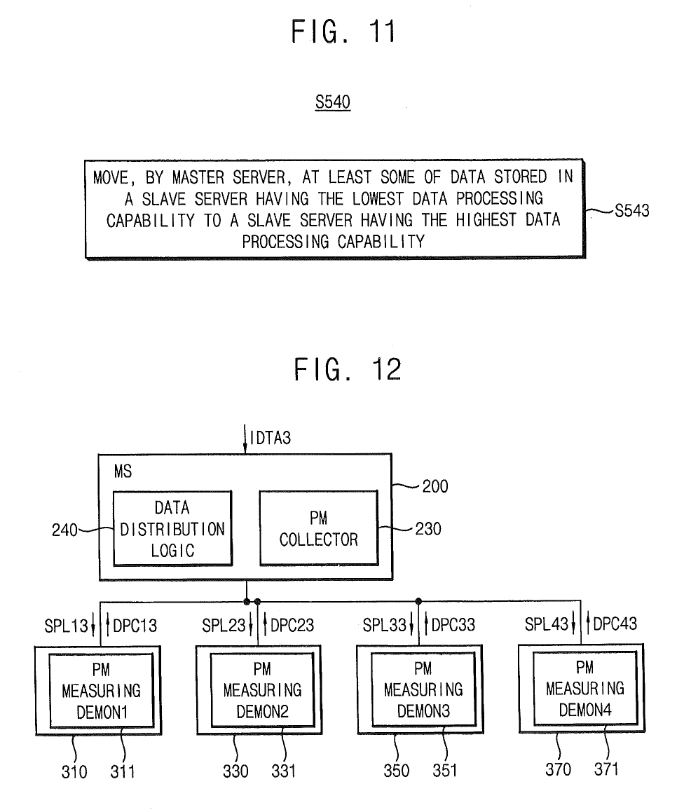

FIG. 10 is a flowchart illustrating methods of operating distributed and parallel data processing system according to example embodiments.

As illustrated in FIG. 10, in a method of operating distributed and parallel data processing system 10 including the master server 200 and the first through third slave servers 310, 330 and 350, the master server 200 divides the user data IDTA into the input equally sized data blocks SPL11, SPL21 and SPL31 which are distributed to the first through third slave servers 310, 330 and 350 (S510). The job manager 210 in the master server 200 may divide the user data IDTA into the input data blocks SPL11, SPL21 and SPL31 to distribute the input data blocks SPL11, SPL21 and SPL31. The user data IDTA may include a user job and Map function or Reduce Function which the user applies and each of the data blocks SPL11, SPL21 and SPL31 may include partitions of the user job and Map function or Reduce Function associated with the partitions.

Each of the first through third slave servers 310, 330 and 350 may calculate first through third data processing capabilities DPC11, DPC21 and DPC31 respectively by measuring time required for processing each of the data blocks SPL11, SPL21 and SPL31 when a map-reduce task is initially performed on each of the data blocks SPL11, SPL21 and SPL31 (S520). The first through third slave servers 310, 330 and 350 may be homogeneous servers having different data processing capabilities or may be heterogeneous servers having different data processing capabilities.

When first through third data processing capabilities DPC11, DPC21 and DPC31 are calculated, the first through third slave servers 310, 330 and 350 transmit the first through third data processing capabilities DPC11, DPC21 and DPC31 to the master server 200 respectively (S530). The performance metric collector 230 including the register 231 of FIG. 5 may store the first through third data processing capabilities DPC11, DPC21 and DPC31.

The data distribution logic 240 of the master server 200 redistributes tasks of the first through third slave servers 310, 330 and 350 based on the first through third data processing capabilities DPC11, DPC21 and DPC31 during an idle time of the distributed and parallel data processing system 10 (S540). The data distribution logic 240 may move at least some of unprocessed data blocks stored in each local disk of the first through third slave servers 310, 330 and 350 among the first through third slave servers 310, 330 and 350.

FIG. 11 illustrates a step of redistributing the task in FIG. 10.

Referring to FIG. 11, the data distribution logic 240 may redistribute at least some of data stored in a source slave server having the lowest data processing capability of the first through third data processing capabilities DPC11, DPC21 and DPC31 to a target slave server having the highest data processing capability of the first through third data processing capabilities DPC11, DPC21 and DPC31 based on the first through third data processing capabilities DPC11, DPC21 and DPC31 such that the target slave server processes the redistributed data block.

For example, when first through third slave servers 310, 330 and 350 have the first through third data processing capabilities DPC11, DPC21 and DPC31 respectively as illustrated in FIG. 6, the master server 200 may move at least some of unprocessed data blocks stored in the local disk of the third slave server 350 to the local disk of the first slave server 310 during the idle time of the distributed and parallel data processing system 10. Accordingly, data processing time of the third slave server 350 having the lowest data processing capability is reduced, and thus the overall data processing time of the distributed and parallel data processing system 10 may be also reduced.

As described above, the data distribution logic 240 may be incorporated in the job manager 210. When the data distribution logic 240 is incorporated in the job manager 210, the job manager 210 may redistribute the unprocessed data blocks stored in the first through third slave servers 310, 330 and 350 among the first through third slave servers 310, 330 and 350 according to the first through third data processing capabilities DPC11, DPC21 and DPC31 during the idle time of the distributed and parallel data processing system 10. When the user requests a new job, the job manager 210 may distribute the new job non-uniformly among the first through third slave servers 310, 330 and 350 based on the first through third data processing capabilities DPC11, DPC21 and DPC31.

FIG. 12 illustrates that a new slave server is added to (or included in) the distributed and parallel data processing system.

Referring to FIG. 12, after each of first through third data processing capabilities DPC11, DPC21 and DPC31 of each of the first through third slave servers 310, 330 and 350 is calculated and processing the user job is complete by the master server 200 redistributing the tasks of the through third slave servers 310, 330 and 350, a fourth slave server 370 is added to the distributed and parallel data processing system 10. The fourth slave server 370 is added because amount of data which the distributed and parallel data processing system 10 processes is increased. The fourth slave server 370 may be heterogeneous server having different data processing capability from the first through third slave servers 310, 330 and 350.

After the fourth slave server 370 is added, user date IDTA3 is input to the master server 200. The fourth slave server 370 includes a performance metric measuring daemon 371 and the fourth slave server 370 may employ the configuration of the first slave server 310 of FIG. 4. The master server 200 divides the user data IDTA into a plurality of data blocks SPL13, SPL23, SPL33 and SPL43 having same data size to allocate the data blocks SPL13, SPL23, SPL33 and SPL43 to the first through fourth slave servers 310, 330, 350 and 370 respectively. The job manager 210 divides the user data IDTA into the data blocks SPL13, SPL23, SPL33 and SPL43 to allocate the data blocks SPL13, SPL23, SPL33 and SPL43. The user data IDTA3 may include a user job and map function or reduce function which the user applies and each of the data blocks SPL13, SPL23, SPL33 and SPL43 may include partitions of the user job and map function or reduce function associated with the partitions.

When the data block SPL34 allocated to the fourth slave server 370 is the same size as each of the data blocks SPL13, SPL23 and SPL33, the performance metric measuring daemon 371 calculates a fourth data processing capability DPC43 by performing MapReduce task on the data block SPL43 to measure a time required for processing the data block SPL43. The performance metric measuring daemon 371 transmits the fourth data processing capability DPC43 to the performance metric collector 230 and the data distribution logic 240 of the master server 200 redistributes unprocessed tasks stored in each local disk of the first through fourth slave servers 310, 330, 350 and 370 based on the first through fourth data processing capabilities DPC13, DPC23, DPC33 and DPC43 during an idle time of the distributed and parallel data processing system 10. The data distribution logic 240 may redistribute at least some of unprocessed data blocks stored in each local disk of the first through fourth slave servers 310, 330, 350 and 370 among the first through fourth slave servers 310, 330, 350 and 370.

When the data block SPL34 allocated to the fourth slave server 370 is a different size compared to the data blocks SPL13, SPL23 and SPL33, each of the first through fourth slave servers 310, 330, 350 and 370 may calculate the first through fourth data processing capabilities DPC13, DPC23, DPC33 and DPC43 respectively using each of performance metric measuring daemons 311, 331, 351 and 371 when the map-reduce task is performed on each of the data blocks SPL13, SPL23, SPL33 and SPL43. Each of the performance metric measuring daemons 311, 331, 351 and 371 may calculate the first through fourth data processing capabilities DPC13, DPC23, DPC33 and DPC43 respectively by measuring time required for processing each of the data blocks SPL13, SPL23, SPL33 and SPL43.

When the first through fourth data processing capabilities DPC13, DPC23, DPC33 and DPC43 are calculated, the first through fourth slave servers 310, 330, 350 and 370 transmit the first through fourth data processing capabilities DPC13, DPC23, DPC33 and DPC43 to the master server 200 respectively. The performance metric collector 230 including the register 231 of FIG. 5 may store the first through fourth data processing capabilities DPC13, DPC23, DPC33 and DPC43.

The data distribution logic 240 of the master server 200 redistributes tasks of the first through fourth slave servers 310, 330, 350 and 370 based on the first through fourth data processing capabilities DPC13, DPC23, DPC33 and DPC43 during an idle time of the distributed and parallel data processing system 10. The data distribution logic 240 may move at least some of unprocessed data blocks stored in each local disk of the first through fourth slave servers 310, 330, 350 and 370 among the first through fourth slave servers 310, 330, 350 and 370.

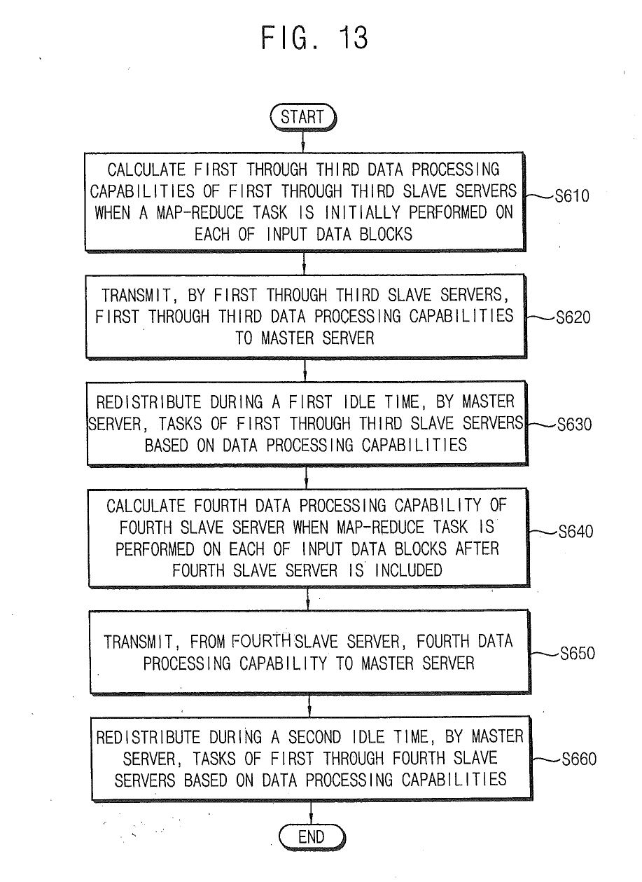

FIG. 13 is a flow chart illustrating a method of operating a distributed and parallel data processing system according to example embodiments.

In FIG. 13, it is assumed that a new slave server (for example, the fourth slave server 370) is added to (or included in) the distributed and parallel data processing system 10.

Referring to FIGS. 1, 12 and 13, before the fourth slave server 370 is added, the master server 200 divides the user data IDTA into the equally sized input data blocks SPL11, SPL21 and SPL31 assigned to the first through third slave servers 310, 330 and 350. Each of the first through third slave servers 310, 330 and 350 may calculate the first through third data processing capabilities DPC11, DPC21 and DPC31 respectively using each of the performance metric measuring daemons 311, 331 and 351 when a map-reduce task is performed on each of the data blocks SPL11, SPL21 and SPL31 (S610). Each of the performance metric measuring daemons 311, 331 and 351 calculate the first through third data processing capabilities DPC11, DPC21 and DPC31 respectively by measuring time required for processing each of the data blocks SPL11, SPL21 and SPL31 when a map-reduce task is initially performed on each of the data blocks SPL11, SPL21 and SPL31. The first through third slave servers 310, 330 and 350 may be homogeneous servers having different data processing capabilities or may be heterogeneous servers having different data processing capabilities.

When first through third data processing capabilities DPC11, DPC21 and DPC31 are calculated, the first through third slave servers 310, 330 and 350 transmit the first through third data processing capabilities DPC11, DPC21 and DPC31 to the performance metric collector 230 of the master server 200 respectively (S620). The data distribution logic 240 of the master server 200 redistributes tasks of the first through third slave servers 310, 330 and 350 based on the first through third data processing capabilities DPC11, DPC21 and DPC31 during a first idle time of the distributed and parallel data processing system 10 (S630). The data distribution logic 240 may move at least some of unprocessed data blocks stored in each local disk of the first through third slave servers 310, 330 and 350 among the first through third slave servers 310, 330 and 350.

After each of first through third data processing capabilities DPC11, DPC21 and DPC31 of each of the first through third slave servers 310, 330 and 350 is calculated and processing the user job is complete by the master server 200 redistributing the tasks of the through third slave servers 310, 330 and 350, a fourth slave server 370 is added to the distributed and parallel data processing system 10.

After the fourth slave server 370 is added, the user date IDTA3 is input to the master server 200. The performance metric measuring daemon 371 calculates the fourth data processing capability DPC43 by measuring a time required for processing the data block SPL43, while performing MapReduce task on the data block SPL43 (S640). The performance metric measuring daemon 371 transmits the fourth data processing capability DPC43 to the performance metric collector 230 (S650). The data distribution logic 240 of the master server 200 redistributes unprocessed tasks stored in each local disk of the first through fourth slave servers 310, 330, 350 and 370 based on the first through fourth data processing capabilities DPC13, DPC23, DPC33 and DPC43 (S660).

When a new slave server is added to the distributed and parallel data processing system 10, the master server 200 may redistribute tasks among the first through fourth slave servers 310, 330, 350 and 370 considering the data processing capability of the new server. Therefore, performance of the distributed and parallel data processing system 10 may be enhanced by reducing overall data processing time of the distributed and parallel data processing system 10.

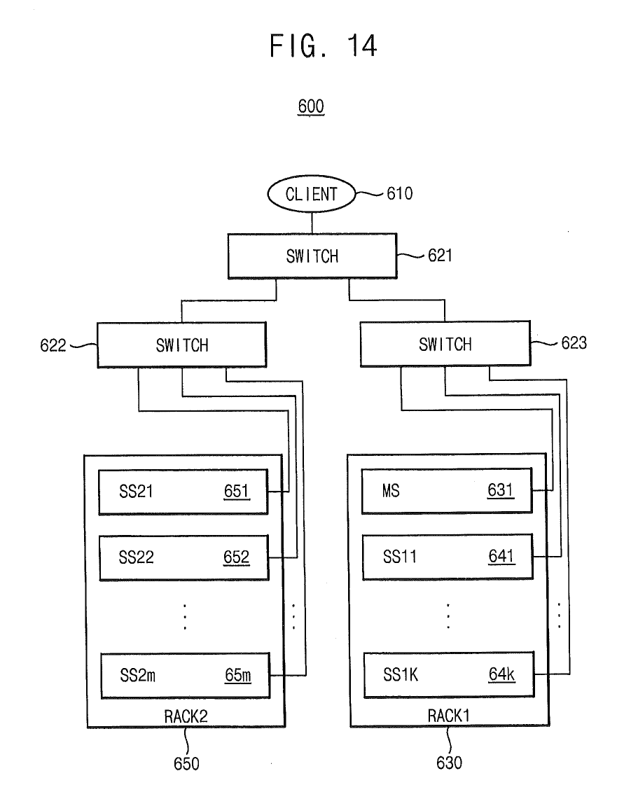

FIG. 14 illustrates physical distribution architecture of Hadoop cluster to which the method according to example embodiments can be applied.

Referring to FIG. 14, a Hadoop cluster 600 may include a client 610, first through third switches 621, 622 and 623 and first and second racks 630 and 650.

The first rack 630 includes at least one master server 631 and a plurality of slave servers 641˜64k and the second rack 650 includes a plurality of slave servers 651˜65m. The first switch 621 connects the client 610 to the second and third switches 622 and 623, the third switch 623 is connected each of the master server 631 and the slave servers 641˜64k and the second switch 622 is connected to each of the slave servers 651˜65m.

The master server 631 may employ a configuration of the master server 200 in FIG. 1. That is, the master server 631 may include a job manager, a performance metric collector and a data distribution logic. The job manager divides user data from the client 621 into a plurality of data blocks to allocate the data blocks to the slave servers 641˜64k and 651˜65m. The performance metric collector may collect a plurality of data processing capabilities from the slave servers 641˜64k and 651˜65m, and the data distribution logic may redistribute tasks of the slave servers 641˜64k and 651˜65m based on the calculated data processing capabilities during idle time of the Hadoop cluster 600.

Each of the slave servers 641˜64k and 651˜65m may employ configuration of the slave server 310 of FIG. 4. That is, each of the slave servers 641˜64k and 651˜65m may include a performance metric measuring daemon, a task manger, and a local disk. Each of the slave servers 641˜64k and 651˜65m may calculate corresponding data processing capability using associated performance metric measuring daemons when the map-reduce task is initially performed on allotted the data block and may transmit the data processing capability to the performance metric collector.

When the Hadoop cluster 600 includes the first and second racks 630 and 650, obstacles due to power supply problem may be prevented and efficiency may be maximized by a physically-single slaver server including a local disk storing actual data and a task manager performing parallel processing.

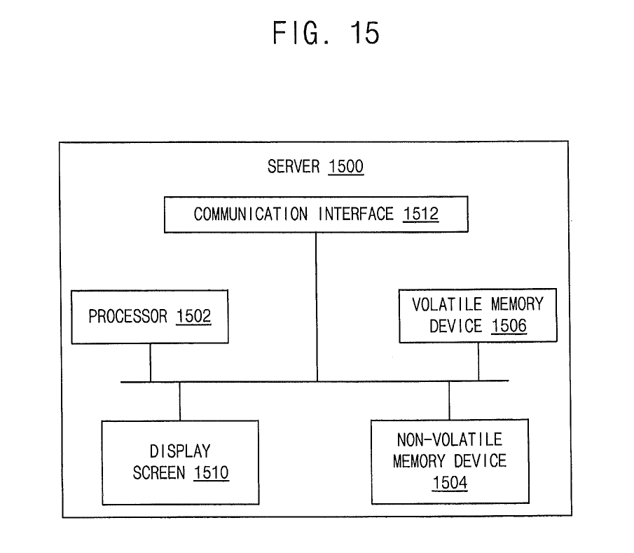

FIG. 15 is a block diagram illustrating embodiments of a master/slave server 1500 (i.e., server) in which embodiments of the present disclosure, or portions thereof, may be implemented as computer-readable code. For example, portions of server 1500 may be implemented in hardware, software implemented with hardware, firmware, tangible computer-readable storage media having instructions stored thereon, or a combination thereof and may be implemented in one or more computer systems or other processing systems. The server 1500 may also be virtualized instances of computers. Components and methods illustrated in FIGS. 1-14 may be embodied in any combination of hardware and software.

Server 1500 may include one or more processors 1502, one or more non-volatile memory devices 1504, one or more memory devices 1506, a display screen 1510 and a communication interface 1512. Server 1500 may also have networking or communication controllers, input devices (keyboard, a mouse, touch screen, etc.) and output devices (printer or display).

Processor(s) 1502 are configured to execute computer program code from memory devices 1504 or 1506 to perform at least some of the operations and methods described herein, and may be any conventional or special purpose processor, including, but not limited to, digital signal processor (DSP), field programmable gate array (FPGA), application specific integrated circuit (ASIC), and multi-core processors.

Non-volatile memory device 1504 may include one or more of a hard disk drive, flash memory, and like devices that may store computer program instructions and data on computer-readable media. One or more non-volatile storage memory device 1504 may be a removable storage device.

Volatile memory device 1506 may include one or more volatile memory devices such as but not limited to, random access memory. Typically, computer instructions are executed using one or more processors 1502 and can be stored in a non-volatile memory device 1504 or volatile memory device 1506. Display screen 1510 allows results of the computer operations to be displayed to a user or an application developer.

Communication interface 1512 allows software and data to be transferred between server 1500 and external devices. Communication interface 1512 may include a modem, a network interface (such as an Ethernet card), a communications port, a PCMCIA slot and card, or the like. Software and data transferred via communication interface 1512 may be in the form of signals, which may be electronic, electromagnetic, optical, or other signals capable of being received by communication interface 1512. These signals may be provided to communication interface 1512 via a communications path. The communications path carries signals and may be implemented using wire or cable, fiber optics, a phone line, a cellular phone link, an RF link or other communications channels. According to some embodiments, a host operating system functionally interconnects any computing device or hardware platform with users and is responsible for the management and coordination of activities and the sharing of the computer resources.

It will be understood that a cloud service model may also be used to provide for example, Infrastructure as a Service (IaaS), Platform as a Service (PaaS), and Software as a Service (SaaS) to implement at least some of the servers in some embodiments according to the inventive concepts. Infrastructure as a Service, delivers computer infrastructure—typically a platform virtualization environment—as a service. Rather than purchasing servers, software, data-center space or network equipment, clients instead buy those resources as a fully outsourced service. Suppliers typically bill such services on a utility computing basis and the amount of resources consumed. Platform as a Service delivers a computing platform as a service. It provides an environment for the deployment of applications without the need for a client to buy and manage the underlying hardware and software layers. Software as a Service delivers software services over the Internet, which reduces or eliminates the need for the client to install and run an application on its own computers, which may simplify maintenance and support.

As mentioned above, a distributed and parallel data processing system including slave servers having different data processing capabilities calculates data processing capability of each slave server while the MapReduce task is initially performed on data block divided from user data and redistributes unprocessed tasks stored in each local disk of each slave server according to the data processing capabilities during idle time of the distributed and parallel data processing system. Therefore, performance of the distributed and parallel data processing system may be enhanced by reducing overall data processing time of the distributed and parallel data processing system.

The example embodiments may be applicable to distributed and parallel data processing system having heterogeneous servers such as Google file system (GFS), Hadoop distributed file system (HDFS), cloud service systems and big data processing systems.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater; a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, server, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, server, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, server, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The foregoing is illustrative of the present inventive concept and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed:

1. A method of operating a distributed and parallel data processing system comprising a master server and at least first through third slave servers, the method comprising:
calculating first through third data processing capabilities of the first through third slave servers for a MapReduce task performed on respective input data blocks provided to each of the first through third slave servers, each MapReduce task running on a respective central processing unit associated with one of the first through third slave servers;
transmitting the first through third data processing capabilities from the first through third slave servers to the master server; and
redistributing, using the master server, tasks assigned to the first through third slave servers based on the first through third data processing capabilities during a first idle time of the distributed and parallel data processing system.

2. The method of claim 1, wherein, when the first slave server has a highest data processing capability among the first through third data processing capabilities and the third slave server has a lowest data processing capability among the first through third data processing capabilities, the redistributing comprises:
moving, using the master server, at least some data stored in the third slave server to the first slave server.

3. The method of claim 2, wherein the at least some data stored in the third slave server corresponds to at least one un-processed data block that is stored in a local disk of the third slave server.

4. The method of claim 1, further comprising:
dividing, using the master server, user data into the input data blocks to be distributed to the first through third slave servers.

5. The method of claim 1, wherein each of the first through third slave servers calculates each of the first through third data processing capabilities using each of first through third performance metric measuring daemons, each included in a respective one of the first through third slave servers.

6. The method of claim 1, wherein the master server receives the first through third data processing capabilities using a performance metric collector.

7. The method of claim 1, wherein the master server redistributes the tasks assigned to the first through third slave servers using a data distribution logic based on the first through third data processing capabilities.

8. The method of claim 1, wherein each of the first through third data processing capabilities is determined based on a respective data processing time determined for the first through third slave servers to process an equal amount of data.

9. The method of claim 1, wherein the first through third slave servers are heterogeneous servers and wherein the first through third data processing capabilities are different from each other.

10. The method of claim 1, wherein the first idle time corresponds to one of a first interval during which the master server has no user data and a second interval during which utilization of the respective central processing units is equal to or less than a reference value.

11. The method of claim 1, wherein the distributed and parallel data processing system processes the user data using a Hadoop framework.

12. The method of claim 1, wherein the system includes a fourth slave server, wherein the method further comprises:
redistributing, using the master server, tasks assigned to the first through fourth slave servers further based on a fourth data processing capability of the fourth slave server during a second idle time of the data processing system.

13. A distributed and parallel data processing system comprising:
a master server; and
at least first through third slave servers connected to the master server by a network, wherein each of the first through third slave servers comprises:
a performance metric measuring daemon configured to calculate a respective one of first through third data processing capabilities of the first through third slave servers using a MapReduce task performed on respective input data blocks provided to each of the first through third slave servers, the data processing capabilities being transmitted to the master server, and
wherein the master server is configured to redistribute tasks assigned to the first through third slave servers based on the first through third data processing capabilities during an idle time of the distributed and parallel data processing system.

14. The distributed and parallel data processing system of claim 13, wherein the master server comprises:
a performance metric collector configured to receive the first through third data processing capabilities; and
data distribution logic associated with the performance metric collector, the data distribution logic configured to redistribute the tasks assigned to the first through third slave servers based on the first through third data processing capabilities.

15. The distributed and parallel data processing system of claim 13, wherein, when the first slave server has a highest data processing capability among the first through third data processing capabilities and the third slave server has a lowest data processing capability among the first through third data processing capabilities, the data distribution logic is configured to redistribute at least some data stored in the third slave server to the first slave server,
wherein each of the first through third salve servers further comprises a local disk configured to store the input data block, and
wherein the master server further comprises a job manager configured to divide user data into the input data blocks to distribute the input data blocks to the first through third slave servers.

16. A method of operating a scalable data processing system comprising a master server coupled to a plurality of slave servers configured to processes data using a Hadoop framework, the method comprising:
determining respective data processing capabilities of each of the slave servers; and
during an idle time, redistributing un-processed data from a lower performance slave server to a higher performance slave server based on the determined respective data processing capabilities.

17. The method of claim 16 wherein determining respective data processing capabilities of each of the slave servers comprises performing respective MapReduce tasks on the slave servers using equal amounts of data for each task.

18. The method of claim 17 wherein the equal amounts of data comprise less than all of the data provided to each of the slave server so that at least some data remains unprocessed when the respective data processing capabilities are determined.

19. The method of claim 16 wherein the idle time comprises an interval where an average utilization of the slave servers is less than or equal to a reference value.

20. The method of claim 16 wherein the data comprises a first job, the method further comprising:
receiving data for a second job; and
distributing the second data unequally among the slave servers based on the respective data processing capabilities of each of the slave servers.
